(19) United States
(12) Patent Application Publication
(10) Pub. No.: US 2005/0194155 A1
(43) Pub. Date: Sep. 8, 2005

(54) Blade pitch control structure for bulldozer

(76) Inventors: Karl R. Dommert, Chattanooga, TN (US); Jason Spitler, Soddy Daisy, TN (US); Masayuki Mukaino, Chattanooga, TN (US)

Correspondence Address: VARNDELL & VARNDELL, PLLC, 106-A S. COLUMBUS ST., ALEXANDRIA, VA, 22314, US

(21) Appl. No.: 10/730,939

(22) Filed: Dec. 10, 2003

(51) Int. Cl. A01B 41/06

(52) U.S. Cl. 172/2

(57) ABSTRACT

A blade pitch control structure for a bulldozer is provided in which angling control of a blade can be performed in a plane parallel to the ground irrespective of the state of pitch control of the blade, thereby realizing good operating accuracy and high operating performance in ground-leveling work. A pin which engages the front end of a pitch support link with a bracket provided on the back side of the blade is constructed as an eccentric pin, and in the eccentric pin, a first shaft part which turnably engages with the front end of the pitch support link and a second shaft part which is fitted into the bracket are mutually eccentric, and the eccentric pin is turned to perform the pitch control.

### BACKGROUND OF THE INVENTION

1. Field of the Invention

The present invention relates to a blade pitch control structure for a bulldozer.

2. Description of the Related Art

As is well known, an earth-moving blade (hereinafter referred to as the blade) is disposed at the front end of a bulldozer, and the back side of the blade is supported by the front end of a vertically swingable blade lifting frame.

In addition, a blade attitude control structure for improving the operating performance of the bulldozer has recently been known. In the blade attitude control structure, the back side of the blade is turnably supported via a universal joint on the front end of the blade lifting frame so that the attitude of the blade that is seen from above can be controlled to be brought into the state of being tilted (hereinafter referred to as the angled state) at an arbitrary angle in either of the counterclockwise and clockwise directions from the state of being perpendicular to the advancing direction of the bulldozer (hereinafter referred to as the angle-zero state) (hereinafter, angling control), and so that the attitude of the blade that is seen from the back side can be controlled to be brought into the state of being tilted (hereinafter referred to as the tilted state) at an arbitrary angle in either of the counterclockwise and clockwise directions from the state of being horizontal (hereinafter referred to as the tilt-angle-zero state) (hereinafter, tilting control), as well as so that the attitude of the blade that is seen from one lateral side, i.e., the tool angle of the blade relative to the ground (hereinafter referred to the pitch), can be controlled (hereinafter, pitch control).

A variety of structures have been considered with respect to the pitch control from among the angling control, the tilting control and the pitch control. As a first example, Patent Document 1 describes a pitch control structure which enables pitch to be selected by extending and shrinking a pitch support link which uses a turnbuckle. As a second example, Patent Document 2 describes a pitch control structure which enables pitch to be selected by changing the method of fitting shim plates, a pitch support link being engaged with a pin attached to a blade via the shim plates.

The first example and the second example of the prior-art blade pitch control structure for a bulldozer that respectively have the structures described in the above-cited Patent Documents 1 and 2 by way of example will be described below in detail with reference to FIGS. 4 to 6.

The first example of the prior-art blade pitch control structure for a bulldozer will be described below with reference to FIG. 4.

FIG. 4 is a perspective view of the first example of the prior-art blade pitch control structure for a bulldozer.

Referring to FIG. 4, the center of the bottom portion of the back side of a blade 30 is turnably supported via a universal joint 31 on the front end of a blade lifting frame 10 which is vertically swingable by means of oil hydraulic cylinders 21, and furthermore, a post 32 provided at the center of the top surface of the blade 30 is turnably engaged with a post 12 provided on the top surface of a support part 11 of the blade lifting frame 10, by a pitch support link 50 which constitutes a turnbuckle with yokes 52 and 53 respectively screwed onto the opposite ends of a screw shaft 51, the pitch of the blade 30 is supported by the pitch support link 50 and a turning center P1 of the post 32 which is engaged with the front end of the link 50 is moved back and forth by extending and shrinking the link 50, whereby the pitch control of the blade 30 can be performed as shown by an arrow P in FIG. 4.

In addition to the above-described pitch control, the angling control and the tilting control of the blade 30 can be performed by oil hydraulic cylinders 22 and an oil hydraulic cylinder 23, respectively.

The second example of the prior-art blade pitch control structure for a bulldozer will be described below with reference to FIGS. 5 and 6.

FIG. 5 is a perspective view of the second example of the prior-art blade pitch control structure. FIG. 6 is a cross-sectional view taken along line M-M of FIG. 5. In FIGS. 5 and 6, the same reference numerals are used to denote the same constituent elements as those shown in FIG. 4, and the same description is omitted hereinafter. Incidentally, in all the drawings that will be described later, the same reference numerals are used to denote the same constituent elements as shown in FIGS. 4, 5 and 6, and the description of the same constituent elements is omitted hereinafter.

As shown in FIGS. 5 and 6, an approximate center of the back side of the blade 30 is turnably supported via the universal joint 31 on the middle portion of the support part 11 of the blade lifting frame 10, and a bracket 33 provided at the center of the bottom portion of the blade 30 is engaged with a pin holding bracket 62 by a pitch support link 61 and pins 61a and 61b. The pin holding bracket 62 is fastened to a seat surface 11a of the back side of the bottom portion of the support part 11 via shim plates 63 and 64 having different thicknesses H1 and H2 by means of a predetermined number of bolts 65. Accordingly, the pitch of the blade 30 is set, and the shim plates 63 and 64 are selectively fitted to the front or the back of the pin holding bracket 62, whereby the turning center P1 of the front end of the link 61 can be selectively moved back and forth as shown in FIG. 6 whereby it is possible to perform the pitch control of the blade 30 as shown by the arrow P in FIG. 6.

Patent Document 1:

U.S. Pat. No. 6,247,540 B1 June/2001 (p. 2, FIG. 2).

Patent Document 2:

U.S. Pat. No. 5,447,204 September/1995 (pp. 2-3, FIGS. 1 and 3).

### SUMMARY OF THE INVENTION

However, in either of the constructions of the first and second examples of the prior-art blade pitch control structure for a bulldozer that have been described above with reference to FIGS. 4, 5 and 6, the pitch of the blade 30 is controlled by moving back and forth the turning center P1 of the front end of the pitch support link 50 (FIG. 4) or 61 (FIG. 6), and this leads to several problems to be described below.

(1) A turning axis PA (FIGS. 4 and 6) of the angling control of the blade 30 is formed by a turning center B1 of the universal joint 31 which supports the blade 30 on the blade lifting frame 10 and the turning center P1 of the front end of the pitch support link 50 (FIG. 4) or 61 (FIG. 6), but since the turning center P1 is moved back and forth by the pitch control, the turning axis PA is incapable of maintaining an attitude perpendicular to the ground, so that it is impossible to perform the angling control of the blade 30 in a plane parallel to the ground.

(2) As the result of the problem (1), when the bulldozer is to perform ground-leveling work, if the angling control of the blade 30 is performed during the advance of the bulldozer, the bottom side of the blade 30 becomes unparallel to the ground, so that the attitude of the blade 30 needs to be corrected by using the tilting control as well. Owing to this fact, the blade pitch control structure becomes low in operating accuracy and operating performance for ground-leveling work.

(3) For the above-described reason (1), since the attitude of the turning axis PA of the angling control of the blade 30 varies with the pitch control, a turning center T1 (FIGS. 4 and 6) of one end of the tilting control oil hydraulic cylinder 23 (FIGS. 4 and 6) cannot be made coincident with the axis of the turning axis PA, so that the tilt attitude of the blade 30 varies with the angling control of the blade 30.

(4) As the result of the above-described problem (3), a phenomenon similar to that described above in Paragraph (2) occurs, so that the blade pitch control structure becomes low in operating accuracy and operating performance for ground-leveling work.

The invention has been made in view of the above-described problems, and an object of the invention is to provide a blade pitch control structure for a bulldozer in which the back side of a blade is turnably supported via a universal joint on the front end of a blade lifting frame to enable attitude control including angling, tilting and pitch control of the blade. In the blade pitch control structure for a bulldozer, the angling control of the blade can be performed in a plane parallel to the ground irrespective of the state of the pitch control with the blade horizontally placed in contact with the ground, thereby realizing good operating accuracy and high operating performance in ground-leveling work.

To achieve the object, a first aspect of the invention provides a blade pitch control structure for a bulldozer, wherein the back side of a blade is turnably supported via a universal joint on the front end of a blade lifting frame to enable attitude control including angling, tilting and pitch control of the blade, a pin which engages the front end of a pitch support link with a bracket provided on the back side of the blade being constructed as an eccentric pin.

According to a second aspect of the invention, in the blade pitch control structure for a bulldozer according to the first aspect of the invention, the eccentric pin has a first shaft part which turnably engages with the front end of the pitch support link and a second shaft part which is fitted into a hole of the bracket, and an axis of the first shaft part and an axis of the second shaft part are mutually eccentric in the state of being spaced apart from each other by a predetermined distance.

According to a third aspect of the invention, in the blade pitch control structure for a bulldozer according to the second aspect of the invention, a line segment which connects a turning center of a universal joint turnably supporting the blade and a turning center about which the front end of the pitch support link is to be turned with respect to the first shaft part of the eccentric pin is arranged to form an axis approximately perpendicular to the ground with the blade horizontally placed in contact with the ground, and a tilting-control oil hydraulic cylinder is engaged with the blade at one end and a turning center of the other end of the tilting-control oil hydraulic cylinder is arranged at a position on the perpendicular axis.

According to a fourth aspect of the invention, in the blade pitch control structure for a bulldozer according to the second aspect of the invention, the eccentric pin is constructed so that a direction in which the first shaft part is made eccentric to the second shaft part is settable continuously at an arbitrary angle about the second shaft part with the second shaft part fitted in a hole of the bracket.

According to the first aspect of the invention, by turning the eccentric pin, it is possible to vary the distance between the front end of the pitch support link and the bracket provided on the back side of the blade, whereby it is possible to perform the pitch control of the blade.

According to the second aspect of the invention, by turning the eccentric pin with the second shaft part of the eccentric pin fitted in the hole of the bracket, it is possible to vary the longitudinal distance between the second shaft part and the first shaft part. On the other hand, the first shaft part is engaged with the front end of the pitch support link and the longitudinal position of the first shaft part is restricted, so that the second shaft part moves back and forth with respect to the first shaft part, and the blade and the bracket in which the second shaft part is fitted move back and forth, whereby it is possible to perform the pitch control. Accordingly, it is possible to perform the pitch control without causing the turning center of the front end of the pitch support link to move back and forth.

According to the third aspect of the invention, since the turning axis of the angling control of the blade is the perpendicular axis, it is possible to perform the angling control of the blade in a plane parallel to the ground. In addition, since the other end of the tilting-control oil hydraulic cylinder turns on the perpendicular axis, the tilt attitude of the blade does not at all vary during the angling control. Furthermore, this advantage can be achieved by the advantage of the second aspect of the invention irrespective of the state of the pitch control.

According to the fourth aspect of the invention, it is possible to perform the pitch control continuously by an arbitrary amount.

Accordingly, it is possible to provide a blade pitch control structure for a bulldozer in which the back side of a blade is turnably supported via a universal joint on the front end of a blade lifting frame to enable attitude control including angling, tilting and pitch control of the blade. In the blade pitch control structure for a bulldozer, the angling control of the blade can be performed in a plane parallel to the ground irrespective of the state of the pitch control with the blade horizontally placed in contact with the ground, thereby realizing good operating accuracy and high operating performance in ground-leveling work.

### BRIEF DESCRIPTION OF THE DRAWINGS

The invention will become more readily appreciated and understood from the following detailed description of a preferred embodiment of the invention when taken in conjunction with the accompanying drawings, in which:

FIG. 1 is a side view of a blade pitch control structure according to an embodiment of the invention;

FIG. 2 is a perspective view of the blade pitch control structure according to the embodiment of the invention;

FIG. 3 is a perspective view of the essential portion of the blade pitch control structure according to the embodiment of the invention;

FIG. 4 is a perspective view of a first example of a prior-art blade pitch control structure;

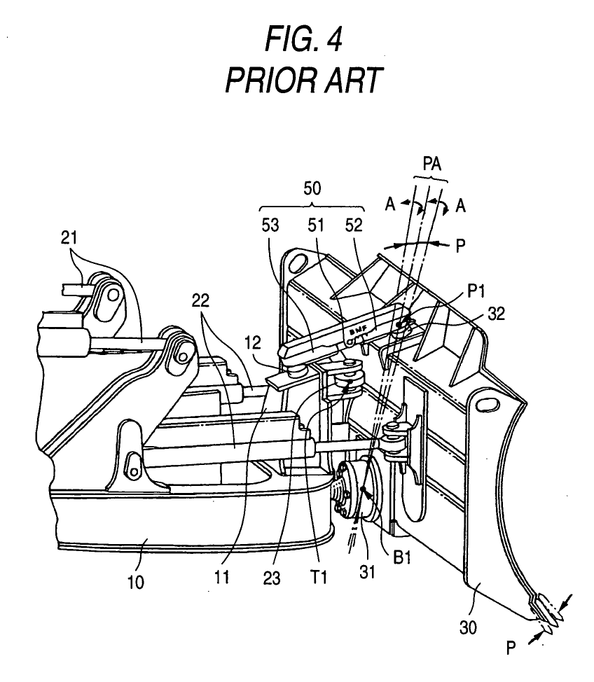

FIG. 5 is a perspective view of a second example of the prior-art blade pitch control structure; and

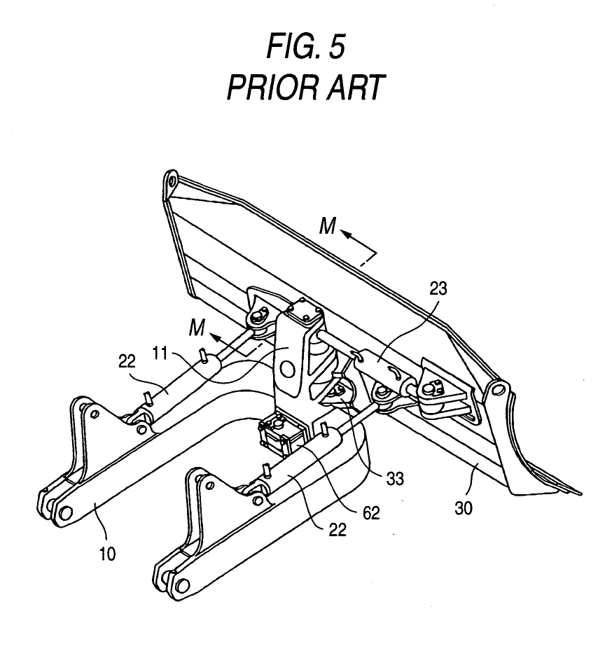

FIG. 6 is a cross-sectional view taken along line M-M in FIG. 5.

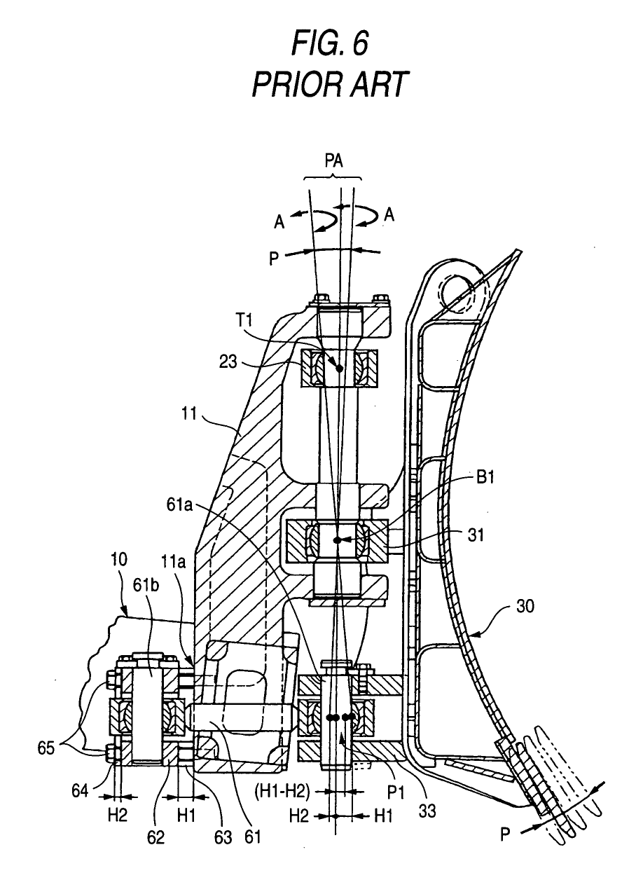

### DETAILED DESCRIPTION OF THE INVENTION

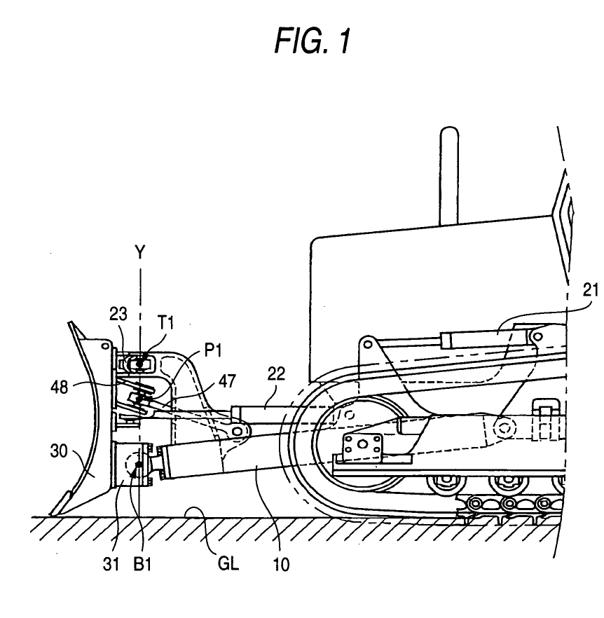

An embodiment of a blade pitch control structure for a bulldozer according to the invention will be described below in detail with reference to FIGS. 1 to 3.

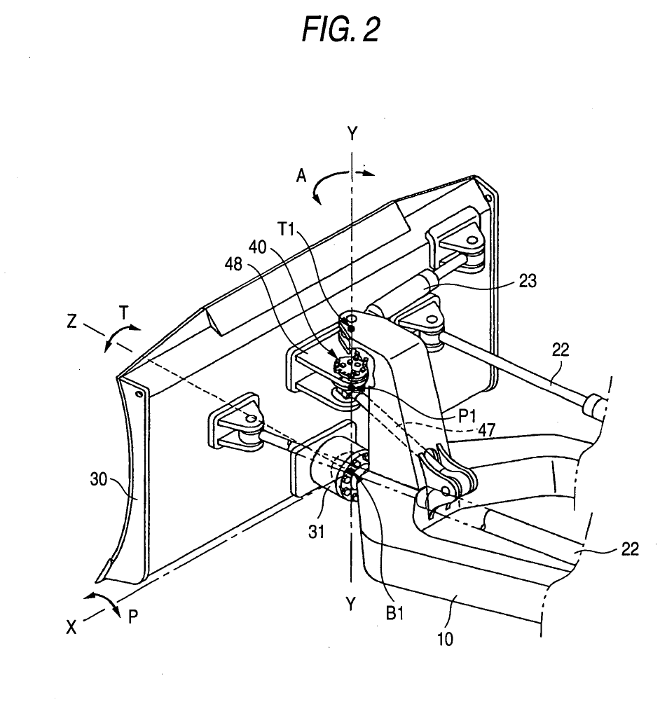

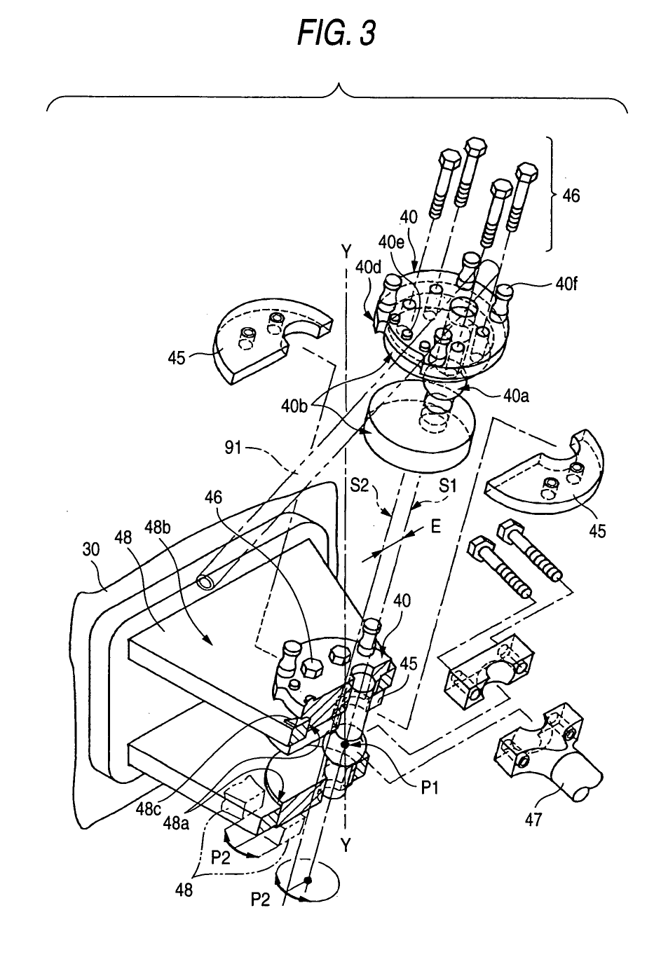

FIG. 1 is a side view of a blade pitch control structure according to the embodiment of the invention, FIG. 2 is a perspective view of the blade pitch control structure, and FIG. 3 is a perspective view of the essential portion of the blade pitch control structure.

First, referring to FIG. 1, a universal joint 31 which turnably supports the back side of a blade 30 on the front end of a blade lifting frame 10 has a turning center B1, and the front end of a pitch support link 47 which engages with a bracket 48 on the back side of the blade 30 and supports the pitch attitude of the blade 30 has a turning center P1, and a line segment which connects the turning center B1 and the turning center P1 forms an axis Y approximately perpendicular to the ground GL with the blade 30 horizontally placed on the ground GL. In addition, a tilting-control oil hydraulic cylinder 23 is engaged with the blade 30 at one end and a turning center T1 of the other end of the tilting-control oil hydraulic cylinder 23 is arranged at a position on the perpendicular axis Y.

Referring to FIG. 2, the turning center B1 of the universal joint 31 and the turning center P1 of the front end of the pitch support link 47 lie on the perpendicular axis Y relative to the ground GL, whereby the blade 30 can perform angling control about the perpendicular axis Y in a plane parallel to the ground GL, as shown by an arrow A in FIG. 2. Furthermore, the turning center T1 of the other end of the oil hydraulic cylinder 23 lies on the perpendicular axis Y, whereby the tilt attitude, shown by an arrow T in FIG. 2, of the blade 30 about a longitudinal axis Z does not at all vary during the angling control.

Furthermore, in FIG. 2, the bracket 48 on the back side of the blade 30 and the front end of the pitch support link 47 are engaged with each other by an eccentric pin 40, and the eccentric pin 40 can be turned to perform pitch control of the blade 30 about a transverse axis X which passes through the turning center B1, as shown by an arrow P in FIG. 2. The pitch control will be described below with reference to FIG. 3.

As shown in FIG. 3, the eccentric pin 40 is constructed in such a manner that a first shaft part 40a which turnably engages with the front end of the pitch support link 47 and a second shaft part 40b which is fitted into a hole 48a of the bracket 48 are joined together by welding and an axis S1 of the first shaft part 40a and an axis S2 of the second shaft part 40b are mutually eccentric in the state of being spaced apart from each other by a predetermined distance E. The eccentric pin 40 is inserted into the hole 48a of the bracket 48, and after the eccentric pin 40 is turned by a desired angle about the second shaft part 40b on the basis of a mark 40e provided on the top surface of the eccentric pin 40 and a mark 48c provided on the top surface of the bracket 48, friction plates 45 are joined together with a predetermined number of bolts 46, and a plate part 48b of the bracket 48 is clamped by a flange portion 40d of the eccentric pin 40 and the friction plates 45 to fix the turning of the eccentric pin 40.

In addition, a predetermined number of projections 40f are fixed to the top surface of the eccentric pin 40 by welding, whereby when the eccentric pin 40 is to be turned by the desired angle, an instrument such as the pipe 91 shown by a dot-dot-dashed line in FIG. 3 is brought into abutment with the projections 40f so that the instrument can assist in turning the eccentric pin 40.

In the above-described construction of the eccentric pin 40 shown in FIG. 3, when the bolts 46 are loosened and the eccentric pin 40 is turned with the pipe 91 or the like, the longitudinal distance between the second shaft part 40b and the first shaft part 40a varies. On the other hand, since the first shaft part 40a is turnably engaged with the front end of the pitch support link 47 and the longitudinal position of the turning center P1 of that engagement portion is restricted on the perpendicular axis Y, the second shaft part 40b moves back and forth with respect to the first shaft part 40a as shown by an arrow P2 in FIG. 3, and the bracket 48 in which the second shaft part 40b is fitted moves back and forth as shown by dot-dot-dashed lines and by an arrow P2 in FIG. 3, whereby the pitch control shown by the arrow P in FIG. 2 can be performed.

According to the above-described construction of the eccentric pin 40, the pitch control of the blade 30 can be performed with the turning center P1 of the front end of the pitch support link 47 maintained on the perpendicular axis Y, whereby the angling control of the blade 30 can be performed about the perpendicular axis Y in a plane parallel to the ground irrespective of the state of the pitch control.

Strictly, while the pitch control is being performed, the bracket 48 moves along the locus shown by the arrow P2 in FIG. 3, and the locus does not coincide with a circular arc (not shown) around the X axis (FIG. 2). Under the influence of this movement, the turning center P1 undergoes a slight deviation from the perpendicular axis Y, but the amount of this deviation is not large, and in practical terms, the turning center P1 can be regarded as being substantially maintained on the perpendicular axis Y as described above.

Incidentally, in the above-described construction of the embodiment shown in FIGS. 1 to 3, the eccentric pin 40 is constructed in such a manner that the first shaft part 40a, the second shaft part 40b and the projections 40f are joined together by welding. The eccentric pin 40 is not limited to the above-described construction, and may also be constructed by casting, forging or the like in part or in whole. Furthermore, the eccentric pin 40 is constructed so that it is manually turned and its turning is fixed by the friction plates 45, but is not limited to the above-described construction. For example, the eccentric pin 40 may also be constructed to be turned or fixed by other means such as an adjustment screw or an oil hydraulic cylinder (neither of which is shown).

As is apparent from the foregoing description, it is possible to provide a blade pitch control structure for a bulldozer in which the back side of a blade is turnably supported via a universal joint on the front end of a blade lifting frame to enable attitude control of the blade such as angling control, tilting control and pitch control. The blade pitch control structure is capable of performing angling control of the blade in a plane parallel to the ground irrespective of the state of pitch control of the blade with the blade horizontally placed in contact with the ground, thereby realizing good operating accuracy and high operating performance in ground-leveling work.

1. A blade pitch control structure for a bulldozer, wherein the back side of a blade is turnably supported via a universal joint on the front end of a blade lifting frame to enable attitude control including angling, tilting and pitch control of the blade, a pin which engages the front end of a pitch support link with a bracket provided on the back side of the blade is constructed as an eccentric pin.

2. The blade pitch control structure for a bulldozer according to claim 1, wherein the eccentric pin has a first shaft part which turnably engages with the front end of the pitch support link and a second shaft part which is fitted into a hole of the bracket, and an axis of the first shaft part and an axis of the second shaft part are mutually eccentric in the state of being spaced apart from each other by a predetermined distance.

3. The blade pitch control structure for a bulldozer according to claim 2, wherein a line segment which connects a turning center of the universal joint turnably supporting the blade and a turning center about which the front end of the pitch support link is to be turned with respect to the first shaft part of the eccentric pin is arranged to form an axis approximately perpendicular to the ground with the blade horizontally placed in contact with the ground, and a tilting-control oil hydraulic cylinder is engaged with the blade at one end and a turning center of the other end of the tilting-control oil hydraulic cylinder is arranged at a position on the perpendicular axis.

4. The blade pitch control structure for a bulldozer according to claim 2, wherein the eccentric pin is constructed so that a direction in which the first shaft part is made eccentric to the second shaft part is settable continuously at an arbitrary angle about the second shaft part with the second shaft part fitted in the hole of the bracket.
